(19) United States
(12) Patent Application Publication
(10) Pub. No.: US 2019/0314963 A1
(43) Pub. Date: Oct. 17, 2019

(54) SCREWDRIVING END FITTING FOR A SCREWDRIVING TOOL AND A SCREWDRIVING TOOL INCLUDING SUCH AN END FITTING

(71) Applicant: Safran Nacelles, GONFREVILLE L'ORCHER (FR)

(72) Inventors: Amaury SPOREN, GONFREVILLE L'ORCHER (FR); Lucile BARGHEON-DUVAL, GONFREVILLE L'ORCHER (FR)

(73) Assignee: Safran Nacelles, GONFREVILLE L'ORCHER (FR)

(21) Appl. No.: 16/456,165

(22) Filed: Jun. 28, 2019

Related U.S. Application Data
(63) Continuation of application No. PCT/FR2017/053740, filed on Dec. 20, 2017.

(30) Foreign Application Priority Data
Dec. 28, 2016 (FR) 16/63483

(51) Int. Cl. B25B 23/14

(52) U.S. Cl. CPC B25B 23/1415

(57) ABSTRACT

A screwdriving end fitting for a screwdriving tool for tightening a self-breaking fastener, such as a self-breaking nut or screw, includes a screwdriving socket and a retention module. The self-breaking fastener includes a threaded portion linked to a screwdriving head via a breaking area. The screwdriving socket of the screwdriving end fitting is capable of cooperating with the self-breaking fastener in order to drive it in rotation, and the retention module retains a broken portion of the self-breaking fastener in the screwdriving socket after the fastener has broken. The retention module includes at least one retainer movable between a locked position in which the retainer inhibits the broken portion of the self-breaking fastener from exiting the screwdriving socket and an unlocked position in which the retainer allows this exit.

### CROSS-REFERENCE TO RELATED APPLICATIONS

This application is a continuation of International Application No. PCT/FR2017/053740, filed on Dec. 20, 2017, which claims priority to and the benefit of FR 16/63483 filed on Dec. 28, 2016. The disclosures of the above applications are incorporated herein by reference.

### FIELD

The present disclosure relates to a screwdriving end fitting for a self-breaking nut or screw and a screwdriving tool including such an end fitting.

### BACKGROUND

The statements in this section merely provide background information related to the present disclosure and may not constitute prior art.

A self-breaking nut is generally of the hexagonal type and includes, along its longitudinal axis, a first portion and a second portion linked by a breakneck. The first portion, having a hexagonal outer shape in the case of a hexagonal nut, constitutes the head of the nut and allows driving the latter in rotation. The second portion is threaded and can be of various outer shapes, and in particular hexagonal or circular shapes. The first portion constitutes a disposable portion, intended to be separated from the second portion by rupturing at the breakneck at a given torque. Thus, the use of such a nut allows avoiding the use of a torque wrench, the nut being designed to break at the desired torque. After breaking, the first portion falls, the second portion remaining in place, being tightened at the desired torque.

When used in large numbers, for example on assembly lines, the self-breaking nuts, however, raises the issue of recovering the disposable portion of the nut. It is indeed desired to recover the disposable portion of each nut in order to avoid pollution of the site or the device being assembled.

A solution to this issue is known from documents U.S. Publication No. 2012/0186405 and U.S. Pat. No. 4,593,583, which provide systems that allow recovering the broken portion of the nut by suction then storing it in a tank linked to the screwdriving tool or in a pouch secured to the screwdriving tool.

These solutions are, however, relatively impractical since they require a vacuum source, are quite or even very cumbersome and, in addition, cannot be adapted to an existing screwdriving tool.

### SUMMARY

The present disclosure proposes to overcome the disadvantages of the state of the art by providing a device for the recovery of the broken portion of a self-breaking nut (or screw) and which can be easily adapted to an existing screwdriving tool.

To this end, the present disclosure concerns a screwdriving end fitting for a screwdriving tool for tightening a self-breaking fastener, such as a self-breaking nut or screw, the fastener including a threaded portion linked to a screwdriving head via a breaking area, the end fitting including a screwdriving socket capable of cooperating with the fastener in order to drive it in rotation, the screwdriving end fitting including a retention module for retaining the broken portion of the fastener in the screwdriving socket after the fastener fastener has broken, the retention module including at least one retaining element, movable between a locked position, in which the retaining element inhibits the broken portion of the fastener from exiting the screwdriving socket, and an unlocked position, in which the retaining element allows this exit.

Thus, by providing a retention module including a retaining element movable between a locking position, in which the screwdriving head of the self-breaking nut is retained in the screwdriving socket, and an unlocking position, in which a nut for tightening or releasing the broken portion of a nut after tightening can be inserted into the screwdriving socket, the retention of the broken portion of a nut is simply and effectively provided. Advantageously, any loss of the broken portion of the nut is avoided by providing a normally locked position of the retaining element, since the operator must voluntarily manipulate the screwdriving end fitting to release it. The screwdriving end fitting in accordance with the present disclosure can be easily obtained by adapting a retention module as defined above to an existing screwdriving end fitting (and therefore to a screwdriving tool which is also an existing one), or natively provided during the design of a screwdriving tool.

In one form, the retaining element is a stop plate movable in translation along an axis perpendicular to the axis of rotation of the screwdriving socket.

In another form, the stop plate includes a circular notch of a diameter smaller than the screwdriving head of the fastener and greater than the diameter of the breaking area of the fastener.

In another form, the retaining element is a retaining socket disposed around the screwdriving socket and movable in rotation about an axis of rotation coinciding with that of the screwdriving socket.

In yet another form, the retaining socket includes at a free end a retaining plate, the retaining plate including a central opening capable of inhibiting the passage of the screwdriving head of the fastener in a first angular position, and capable of allowing such a passage in a second angular position.

In still another form, the central opening is of a hexagonal shape in order to cooperate with a fastener with a hexagonal head.

In a further form, the distance between the parallel edges of the central opening is greater than the distance between the parallel faces of the head of the fastener, and less than the distance between the ridges linking two adjacent faces of the head of the fastener.

In another form, the retaining socket includes at a free end at least one jaw movable in rotation relative to the retaining socket, between a first position in which the jaw is capable of inhibiting the passage of the screwdriving head of the fastener and a second position in which the jaw is capable of allowing such a passage.

In yet another form, the jaw is hinged on the retaining socket and includes a slot cooperating with a pin fixed relative to the retaining socket.

In still another form, the retention module includes two opposite rotary jaws.

In another form, the retention module includes elastic reminders for biasing the retaining element toward its locked position.

The present disclosure also concerns a screwdriving tool including a screwdriving end fitting as defined above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a screwdriving tool including a screwdriving end fitting in accordance with the present disclosure;

FIG. 2a is a perspective view of the screwdriving end fitting of FIG. 1 in the locked position;

FIG. 2b is a side view of screwdriving end fitting of FIG. 1 in the locked position;

FIG. 3a is a perspective view of the screwdriving end fitting of FIG. 1 in the unlocked position;

FIG. 3b is a side view of screwdriving end fitting of FIG. 1 in the unlocked position;

FIG. 4 is a perspective view of a screwdriving tool including a second example of a screwdriving end fitting in accordance with the present disclosure;

FIG. 5a is a perspective view of the screwdriving end fitting of FIG. 4;

FIG. 5b is a front view of the screwdriving end fitting of FIG. 4 in the locked position;

FIG. 5c is a front view of the screwdriving end fitting of FIG. 4 in the unlocked position;

FIG. 6a is a perspective view of a screwdriving end fitting having a straight axis in accordance with the present disclosure;

FIG. 6b is a partial view of one form of a screwdriving end fitting having an offset axis and in the unlocked position in accordance with the present disclosure; and

FIG. 6c is a partial view of another form of a screwdriving end fitting having an offset axis and in the locked position in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

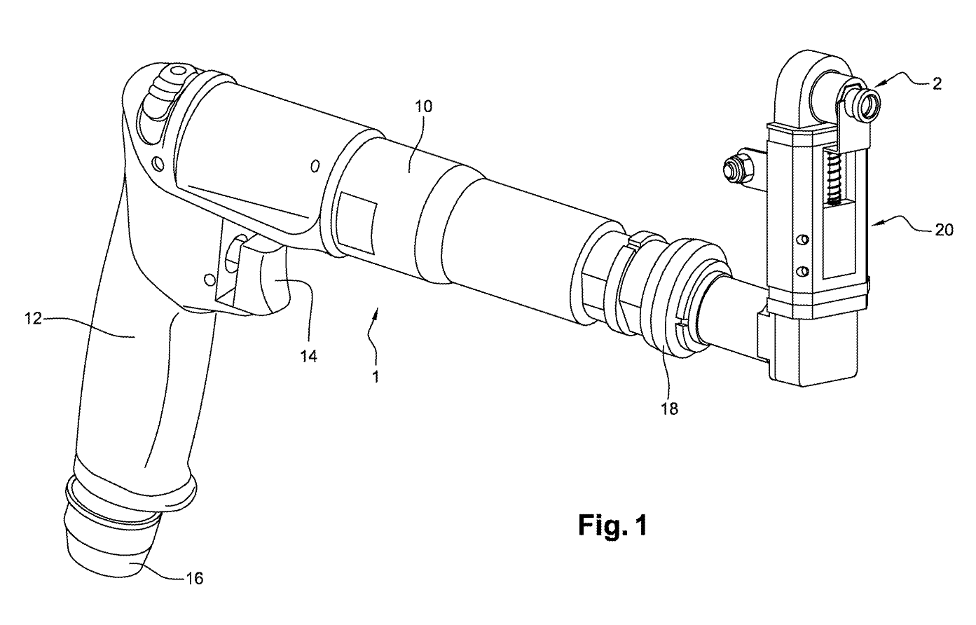

FIG. 1 shows a screwdriving tool 1, or screwdriver, equipped with a screwdriving end fitting 20 in accordance with the present disclosure, allowing to drive a self-breaking type nut 2. The screwdriver 1 is in the example of FIG. 1 an offset axis type screwdriver. The screwdriver 1 includes a body 10, at one end of which a gripping handle 12 is disposed. The handle 12 includes an actuating trigger 14. The lower end of the handle 12 includes a connection device 16 allowing to connect the screwdriver 1 to a power source, for example a source of electrical or pneumatic power. At an end opposite to the handle 12, the body 10 includes a connection end fitting 18, allowing the connection of a screwdriving end fitting 20.

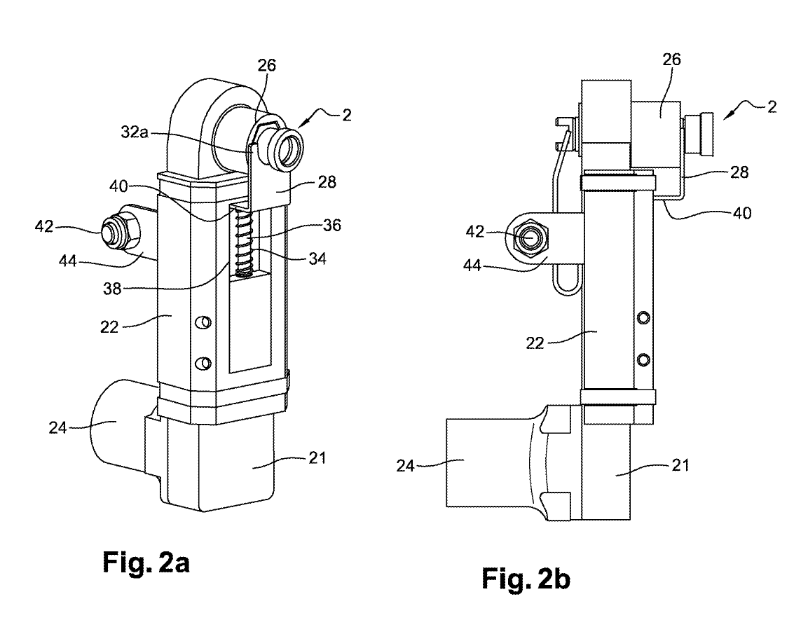

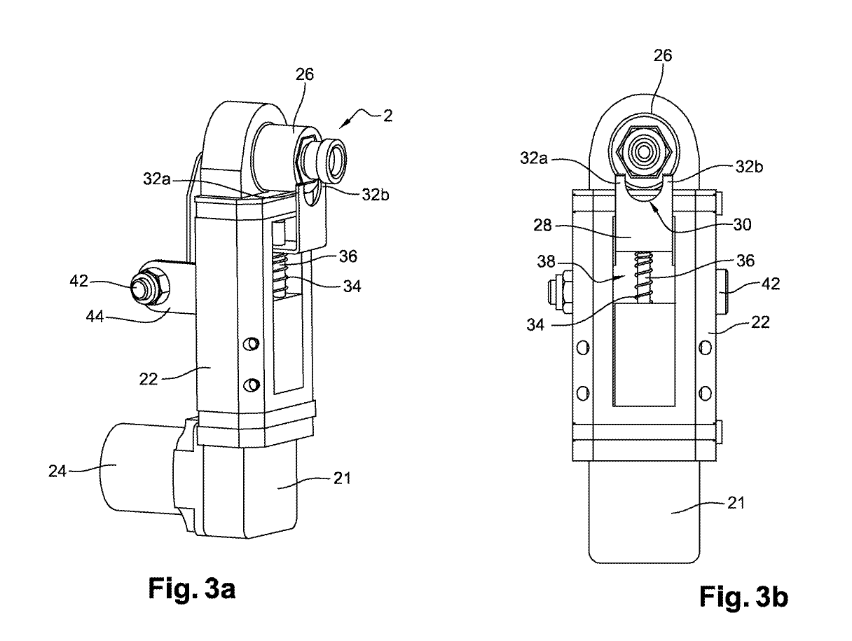

The screwdriving end fitting 20, better visible in FIGS. 2a, 2b and 3a, 3b, is of the offset axis type. It includes a body 21, elongated along a longitudinal axis perpendicular to the axis of rotation of the screwdriver 1. A connection device 24 is disposed at a lower end of the body 21, allowing the connection of the screwdriving end fitting 20 to a screwdriver. The device 24 is oriented along an axis perpendicular to the longitudinal axis of the body 21. At an upper end, the body 21 includes a screwdriving socket 26, provided to drive the nut 2, in the example of hexagonal shape. In a known manner, the socket 26 is driven in rotation by the screwdriver 1 to which the screwdriving end fitting 20 is connected, via an internal movement transmission device (not shown).

In accordance with the present disclosure, the screwdriving end fitting 20 includes a module 22 for retaining the broken portion of the self-breaking nut 2. The module 22 includes a body disposed on the screwdriving end fitting 20 body 21. The module 22 includes a retaining element, in the example of FIGS. 1 to 3b in the form of a stop plate 28, movable in translation in a direction parallel to the longitudinal axis of the body 21, and therefore perpendicular to the axis of rotation of the socket 26. The stop plate 28 is movable between a locked position (shown in FIGS. 2a and 2b) and an unlocked position (shown in FIGS. 3a and 3b). In the unlocked position, the stop plate 28 is in a low position, in which it does not interfere with the passage of the self-breaking nut 2 for its insertion into the screwdriving socket 26, and in which it therefore does not inhibit the extraction of the nut 2 from the screwdriving socket 26. In the locked position, the stop plate 28 is in a high position, in which it partially covers the screwdriving socket 26 in order to inhibit the exit of the broken portion of the nut 2. To this end, the stop plate 28 includes on its upper edge a circular notch 30, having a diameter smaller than that of the hexagonal segment of the nut 2 but greater than the diameter of the breakneck of the nut 2. Thus, the circular notch 30 delimits at the upper end of the stop plate 28 two branches 32a, 32b, which are positioned on either side of the breakneck of the nut when the stop plate 28 is in the locked position.

In the example of FIGS. 1 to 3b, the retaining element of the retention module 22, that is to say the stop plate 28, is biased toward its locked position by elastic reminders. These elastic reminders are in the example a helical spring 34 wound along a rod 36 extending along the longitudinal axis of the body 21 and disposed in a through cavity 38 provided in the body of the module 22. The upper end of the spring 34 is bearing on an abutment plate 40 secured to the stop plate 28, while the lower end of the spring 34 is bearing on a lower end of the cavity 38. The stop plate 28 is thus in a normally locked position, which allows avoiding any loss of the broken portion of the nut 2 at the end of a tightening operation.

In order to switch the stop plate 28 from its locked position to its unlocked position, the retention module includes in the example a manual actuating rod 42. The actuating rod is secured to the stop plate 28, via the abutment plate 40 and a linking plate 44. In the example, the actuating rod 42 is located behind the body 22, that is to say on the side opposite to the screwdriving socket 26. It is therefore understood that the set formed by the stop plate 28, the abutment plate 40 and the linking plate 44 (which form in the example, one single piece) passes through the cavity 38. The actuating rod 42 thus allows an operator to lower the retaining element constituted by the stop plate 28, in order to allow the insertion then the extraction of the nut 2. Thus, during a tightening operation, the operator lowers the actuating rod 42 in order to insert a nut to be tightened in the socket 26, then releases the actuating rod to proceed with the tightening. Once the tightening is completed, the broken portion of the nut is retained in the screwdriving socket 26 by the stop plate 28 as long as the operator does not lower the actuating rod 42 again. This last manipulation can therefore be performed at the desired time and place, for example above a recovery container.

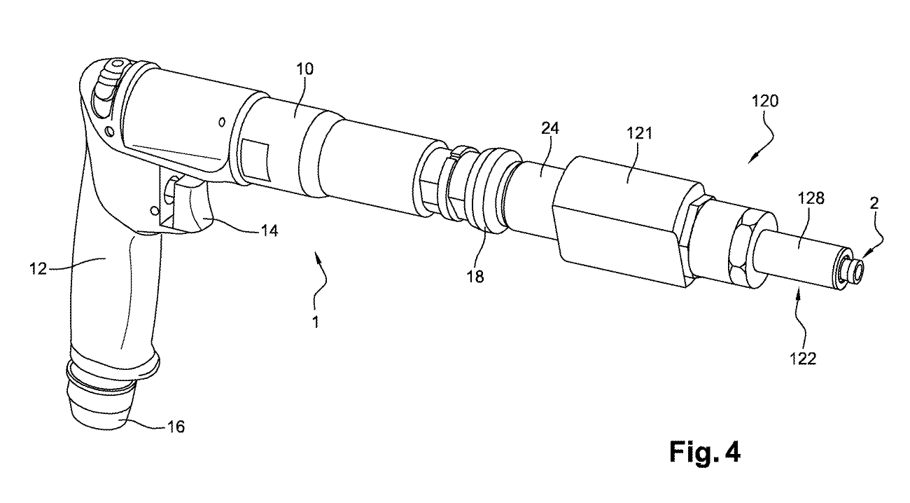

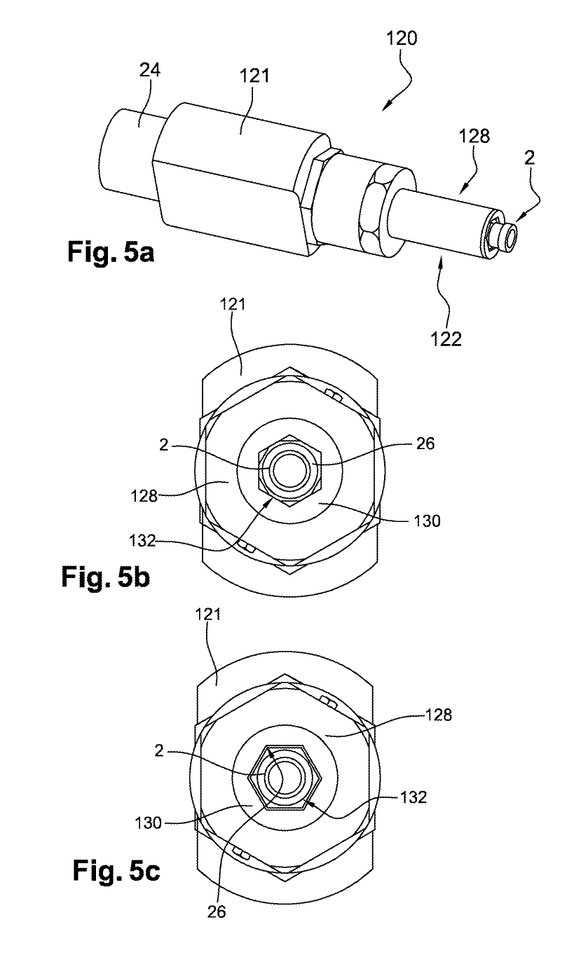

FIGS. 4 to 5c show a second exemplary form of the present disclosure. The screwdriver 1 of FIG. 4 is equipped with a screwdriving end fitting 120 of the straight type, that is to say with a non-offset axis. The screwdriving end fitting 120 includes a body 121, elongated along a longitudinal axis coinciding with the axis of rotation of the screwdriver 1. At a first end of the body 121, the screwdriving end fitting 120 includes a connection device 24 allowing the connection to a screwdriver. At an opposite end, the screwdriving end fitting 120 includes a screwdriving socket 26. The screwdriving socket 26 is disposed inside the retention module 122 which includes a retaining socket 128 constituting in the example the retaining element of the module 122. The retaining socket 128 is thus movable in rotation about the longitudinal axis, between a locked position (visible in FIG. 5b), in which it inhibits the exit of a nut positioned within the screwdriving socket 26, and an unlocked position (visible in FIG. 5c), in which it allows this exit. To this end, the retaining socket 128 includes at its free end a retaining plate 130, in the form of a disc including a central opening 132. The shape and dimensions of the central opening 132 are such that the retaining plate 130 blocks the hexagonal portion of the nut 2 in the screwdriving socket 26 when the retaining socket 128 is in the locked position, and does not oppose the passage of the nut when the retaining socket 128 is in the unlocked position. In the example, the opening 132 has a hexagonal shape having dimensions such that the distance between the parallel edges of the opening 132 is greater than the distance between the parallel faces of the hexagonal portion of the nut, but less than the distance between two opposite peaks of the head of the nut.

The retention module 122 shown in FIGS. 4 to 5c includes elastic reminders biasing the retaining socket 128 toward its locked position. Thus, the retaining socket is in the normally locked position, and an operator can easily switch it to its unlocked position by rotating it about its axis of rotation, while introducing or releasing the head of a nut. In the example, the elastic reminders include a spring (not shown) disposed inside the retaining socket 128.

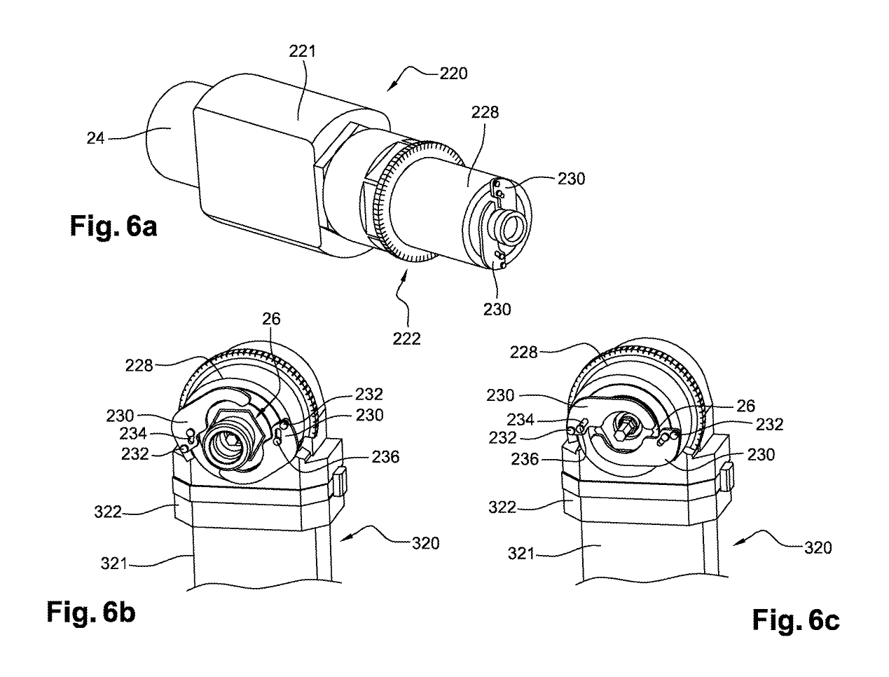

A third and a fourth exemplary form of the present disclosure are shown in FIGS. 6a to 6c. FIGS. 6a on the one hand, and 6b, 6c on the other hand, show screwdriving end fittings 220, 320, respectively of the straight and the offset axis type, in which the retention module 222, 322 includes rotary jaws.

In FIG. 6a, the screwdriving end fitting 220 is of the straight type. This screwdriving end fitting includes a body 221, elongated along a longitudinal axis coinciding with the axis of rotation of the screwdriver 1. The screwdriving end fitting 220 includes a connection device 24 and a screwdriving socket 26. The screwdriving socket 26 is disposed inside the retention module 222 which includes a retaining socket 228. The retaining socket 228 includes at its free end two jaws 230 constituting in the example the retaining element of the retention module. The retaining socket 228 is thus movable in rotation about the longitudinal axis, between a locked position in which the jaws 230 inhibit the exit of a nut positioned within the screwdriving socket 26, and an unlocked position, in which the jaws authorize this exit. To this end, each jaw 230 is movable in rotation, about an axis of rotation parallel to the axis of rotation of the screwdriver. The operation of the jaws 230 is detailed hereinafter, in connection with FIGS. 6b and 6c, which show an offset axis screwdriving end fitting 320.

The screwdriving end fitting 320 is shown partially in FIGS. 6b and 6c. It includes a body 321 on which is disposed a screwdriving socket 26. The retention module 322 is disposed on the body 321 and integrates the retaining socket 228 equipped with the jaws 230. Each jaw 230 is hinged on an axis 232 disposed at the periphery of the free end of the retaining socket 228. The axes 232 of the two jaws 230 are diametrically opposite. In order to obtain the switch of the jaws from the unlocked position (FIG. 6b) to the locked position (FIG. 6c), each jaw 230 includes a slot 234 cooperating with a pin 236 fixed relative to the body 322. As shown in FIGS. 6b and 6c, the rotation of the retaining socket 228 relative to the body 322 (or relative to the body 222 in the example of FIG. 6a) will induce a relative displacement of each pin 236 relative to each axis 232 of rotation. This relative displacement leads to the closing or the opening of the jaws 230 depending on the direction of rotation of the retaining socket 228. As for the previous exemplary forms, the retaining socket 228 (and therefore the jaws 230) will advantageously be biased toward its locked position by elastic reminders.

It was seen that the retention module in accordance with the present disclosure allows for simple and efficient recovery of the broken portion of a self-breaking fastener. Furthermore, a module in accordance with the present disclosure can be easily integrated into an existing screwdriving end fitting and therefore into an existing screwdriving tool.

Although the present disclosure has been described in connection with particular examples of various forms, it is quite obvious that it is in no way limited thereto and that it comprises all the technical equivalents of the described means as well as the combinations thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A screwdriving end fitting for a screwdriving tool for tightening a self-breaking fastener, the self-breaking fastener including a threaded portion linked to a screwdriving head via a breaking area, the screwdriving end fitting comprising:
a screwdriving socket that cooperates with the self-breaking fastener and drives the self-breaking fastener in rotation; and
a retention module for retaining a broken portion of the self-breaking fastener in the screwdriving socket after the self-breaking fastener has broken, the retention module including at least one retainer movable between a locked position in which the at least one retainer inhibits the broken portion of the self-breaking fastener from exiting the screwdriving socket and an unlocked position in which the at least one retainer allows the self-breaking fastener to exit.

2. The screwdriving end fitting according to claim 1, wherein the at least one retainer is a stop plate movable in translation along an axis perpendicular to an axis of rotation of the screwdriving socket.

3. The screwdriving end fitting according to claim 2, wherein the stop plate includes a circular notch having a diameter smaller than a diameter of the screwdriving head of the self-breaking fastener and greater than a diameter of the breaking area of the self-breaking fastener.

4. The screwdriving end fitting according to claim 1, wherein the at least one retainer is a retaining socket disposed around the screwdriving socket and movable in rotation about an axis of rotation coinciding with that of the screwdriving socket.

5. The screwdriving end fitting according to claim 4, wherein the retaining socket includes, at a free end, a retaining plate, the retaining plate including a central opening that inhibits passage of the screwdriving head of the self-breaking fastener in a first angular position and allows passage of the screwdriving head in a second angular position.

6. The screwdriving end fitting according to claim 5, wherein the central opening is a hexagonal shape.

7. The screwdriving end fitting according to claim 6, wherein a distance between parallel edges of the central opening is greater than a distance between parallel faces of the screwdriving head of the self-breaking fastener and less than a distance between ridges linking two adjacent faces of the screwdriving head of the self-breaking fastener.

8. The screwdriving end fitting according to claim 4, wherein the retaining socket includes at a free end at least one jaw movable in rotation, relative to the retaining socket, between a first position in which the at least one jaw inhibits passage of the screwdriving head of the self-breaking fastener and a second position in which the at least one jaw allows passage of the screwdriving head.

9. The screwdriving end fitting according to claim 8, wherein the at least one jaw is hinged on the retaining socket and includes a slot cooperating with a pin fixed relative to the retaining socket.

10. The screwdriving end fitting according to claim 8 further comprising two opposite rotary jaws.

11. The screwdriving end fitting according to claim 1 further comprising elastic reminders for biasing the at least one retainer toward its locked position.

12. A screwdriving tool comprising:
a screwdriving end fitting for tightening a self-breaking fastener including a threaded portion linked to a screwdriving head via a breaking area,
wherein the screwdriving end fitting includes a screwdriving socket that cooperates with the self-breaking fastener and a retention module for retaining a broken portion of the self-breaking fastener in the screwdriving socket after the self-breaking fastener has broken, the retention module including at least one retainer movable between a locked position in which the at least one retainer inhibits the broken portion of the self-breaking fastener from exiting the screwdriving socket and an unlocked position in which the at least one retainer allows the self-breaking fastener to exit.
